(19) United States
(12) Patent Application Publication
(10) Pub. No.: US 2003/0197957 A1
(43) Pub. Date: Oct. 23, 2003

(54) Extendable magnifier

(76) Inventor: Shun Liu, Taipei Hsien (TW)

Correspondence Address: Shun Liu, P.O. Box No.6-57, Chung-Ho, Taipei, 235, TW

(21) Appl. No.: 10/125,377

(22) Filed: Apr. 19, 2002

(51) Int. Cl. G02B 27/02

(52) U.S. Cl. 359/803

(57) ABSTRACT

An extendable magnifier mainly has a case body assembled by an upper case body and a lower case body; a receiving space is formed on the case body and an extendable and contractible lens frame is disposed in the receiving space; a magnifying lens is disposed on the lens frame; when being pushed outwardly, the lens frame presses an elastic tab switch hidden in the case body to light up a photo-diode with high brightness and disposed at the front aspect of the case body for illuminating application.

### BACKGROUND OF THE INVENTION

1) Field of the Invention

The present invention relates to an extendable magnifier mainly comprises an extendable and contractible lens frame disposed in a receiving space on the case body; a magnifying lens is disposed on the lens frame; when being pushed outwardly, the lens frame presses an elastic tab switch hidden in the case body to light up a photo-diode with high brightness and disposed at the front aspect of the case body for illuminating application.

2) Description of the Prior Art

Accordingly, usually a magnifier is used to observe to see if there is any flaw or line on the surface of a fine or precious object.

It is hard to use the magnifier to see the detail portion of a certain object when the ambient light is dim. Under this situation, it is necessary to lighten the area for facilitating observation. This can be done indoors by simply adjusting the angle of a table lamp. However, without any artificial light source and enough natural light, it becomes very inconvenient and hard to observe the detail portion of an object outdoors.

In view of the abovementioned shortcomings of the conventional magnifier, the inventor of the present invention designed an extendable magnifier mainly assembled by a case body and a lens frame, wherein the upper case body and the lower case body form a receiving space; the lens frame is disposed in the receiving space. The upper case body has two slide grooves; an outer end of one of the slide grooves is disposed with a pair of elastic tab switches hidden in and not protruding outside the case body. A photo-diode with high brightness is disposed at the front end of the lower case body and a battery is disposed inside the lower case body. Two L-shape guide blocks opposite the slide grooves of the lower case body are disposed on the bottom plane of the lens frame. According to the abovementioned structure, to push the lens frame outside the receiving space makes the L-shape guide block press the elastic tab switch in the lower case body thereby lighting up the photo-diode with high brightness for illuminating application.

### SUMMARY OF THE INVENTION

Therefore, the primary objective of the present invention is to provide a magnifier structure comprising a extendable lens frame disposed in a receiving space of a case body; a magnifier lens is disposed on the lens frame such that pushing the lens frame outwardly lightens up a photo-diode with high brightness and disposed at the front aspect of the case body for illuminating application.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a perspective drawing of the present invention.

FIG. 2 is a perspective and exploded drawing of the present invention.

FIG. 3 is a cross-sectional drawing of the assembly of a not being pushed lens frame of the present invention.

FIG. 4 is a perspective drawing of an elastic tab switch disposed in a lower case body of the present invention.

FIG. 5 is a cross-sectional drawing of the assembly of a lens frame being pushed outwardly of the present invention.

FIG. 6 is a perspective and schematic drawing of the lens frame pressing against the elastic tab switch of the present invention.

FIG. 7 is a perspective and schematic drawing of the lens frame not pressing against the elastic tab switch of the present invention.

FIG. 8 is a lateral view drawing of a retaining clip disposed on the present invention.

FIG. 9 is a bottom view drawing of the present invention.

FIG. 10 is a schematic drawing of the present invention clipped onto a waist belt.

FIG. 11 is a schematic drawing of the present invention hanging around a neck portion.

### DETAILED DESCRIPTION OF THE PREFERRED EMBODIMENTS

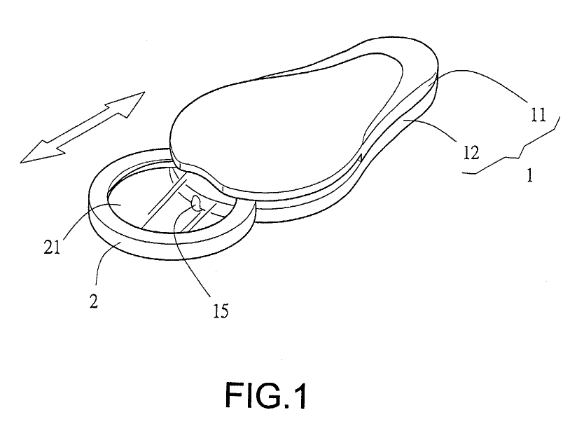

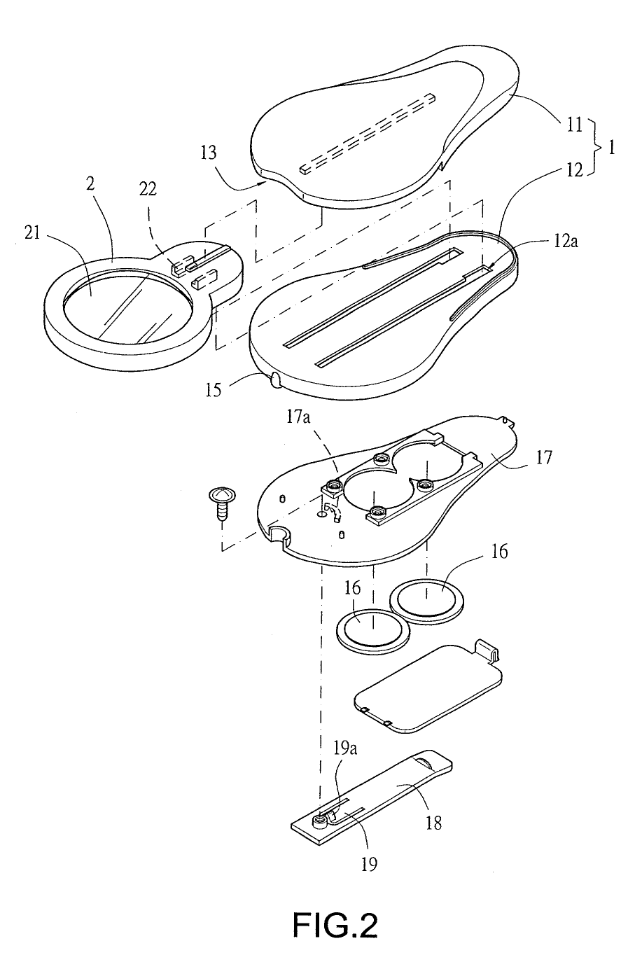

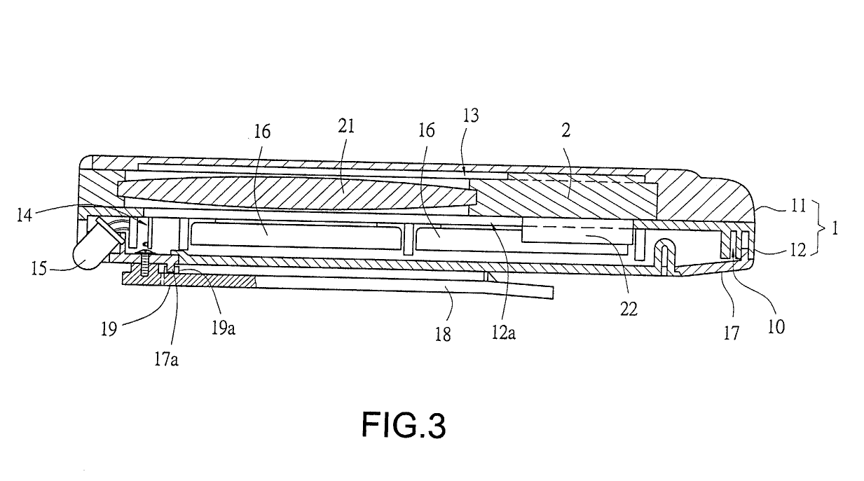

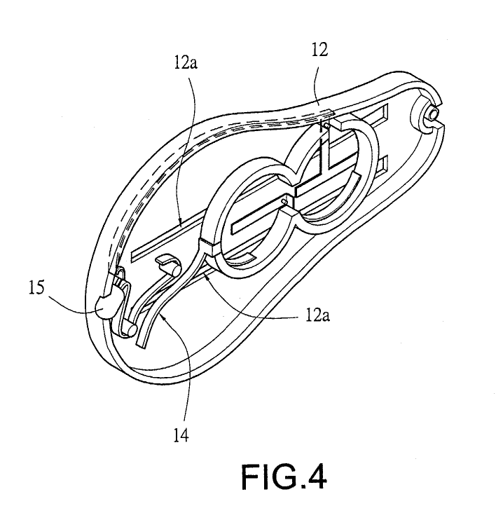

Referring to FIGS. 1 and 2, the present invention comprises a case body (1) assembled by an upper case body (11) and a lower case body (12); a receiving space (13) is formed between the upper case body (11) and the lower case body (12); two slide grooves (12a) are disposed on the bottom plane of the lower case body (12); an outer end of one of the slide grooves (12a) is disposed with a pair of elastic tab switches (14) hidden in and not protruding outside the case body (1), as shown in FIGS. 3 and 4. A photo-diode (15) with high brightness is disposed at the front end of the lower case body (12) and a battery (16) is disposed inside the lower case body (12).

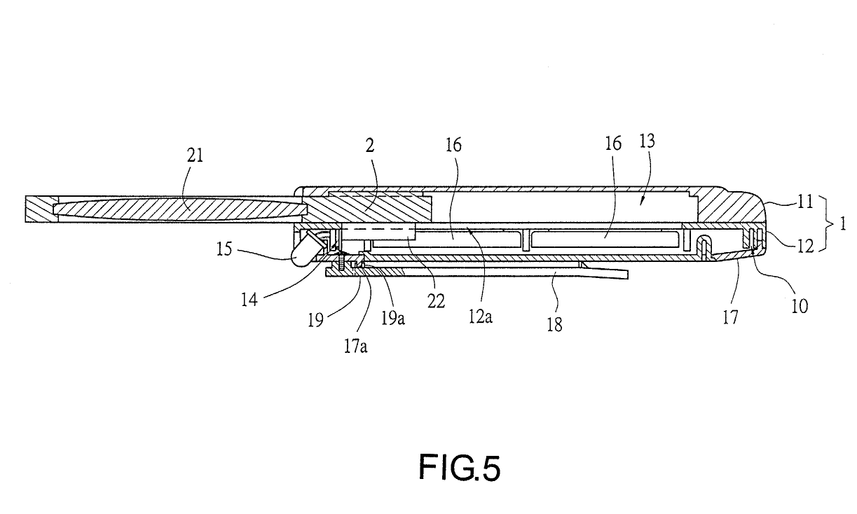

A lens frame (2) is disposed in the receiving space (13) of the case body (1); a magnifying lens (21) is disposed on the lens frame (2). Two L-shape guide blocks (22) opposite the slide grooves (12a) of the lower case body (12) are disposed on the bottom plane of the lens frame (2) allowing the lens frame (2) to extend outside or contract into the receiving space (13) of the case body (1), as shown in FIGS. 3 and 5.

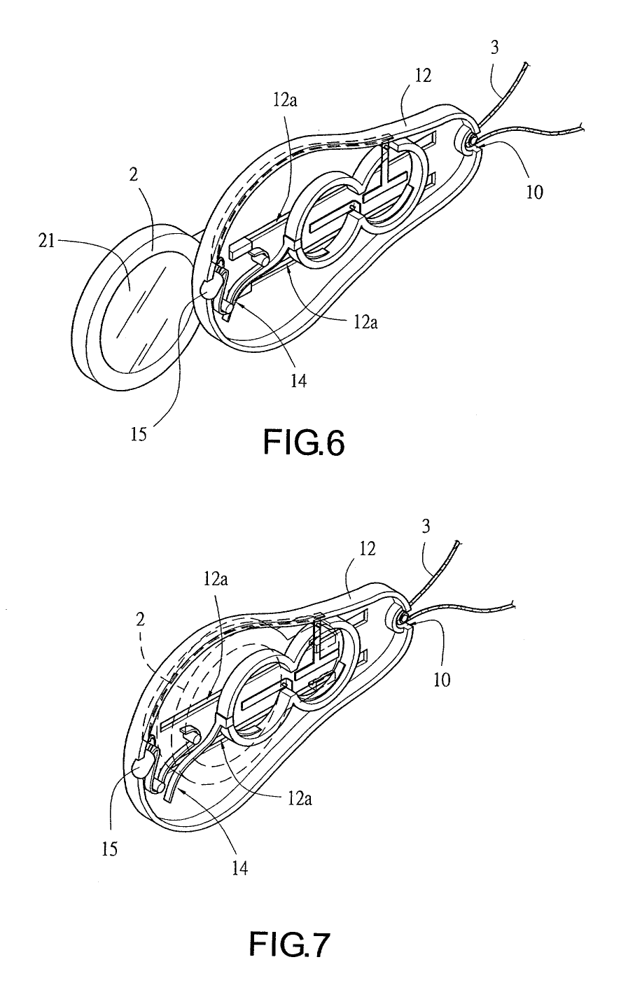

According to the abovementioned structure, when in use, the lens frame (2) is pushed outwardly, as indicated in FIG. 5, to lean against the slide groove (12a) of the upper case body (12) of the case body (1) via the L-shape guide block (22) to slide outwardly. When the lens frame (2) is pushed outside the receiving space (13), the L-shape guide block (22) on the lens frame (2) presses the elastic tab switch (14) on the distal end of the slide groove (12a) on the lower case body (12) so as to communicate the electricity, as shown in FIG. 6, and to light up the photo-diode (15) with high brightness and disposed at the front aspect of the lower case body (12). In another word, pushing the lens frame (2) outwards automatically lights up the photo-diode (15) with high brightness. Therefore, when using the magnifying lens (21) on the lens frame (2) to observe a fine object, the photo-diode (15) with high brightness provides illumination for facilitating detail observation.

Contrarily, when pushing the lens frame (2) back to the receiving space (13) of the case body (1) for storage, as indicated in FIG. 7, the L-shape guide block (22) moves away from the elastic tab switch (14) on the distal end of the slide groove (12a) on the lower case body (12) thereby causing a short circuit situation so as to synchronously turn off the photo-diode (15) with high brightness. Therefore, the trouble of separately turning on or off the photo-diode (15) with high brightness is eliminated.

Since the elastic tab switch (14) is hidden inside the case body (1) and pushed by the lens frame (2) to communicate or shut down the electricity, its on/off switch does not expose on the case body (1).

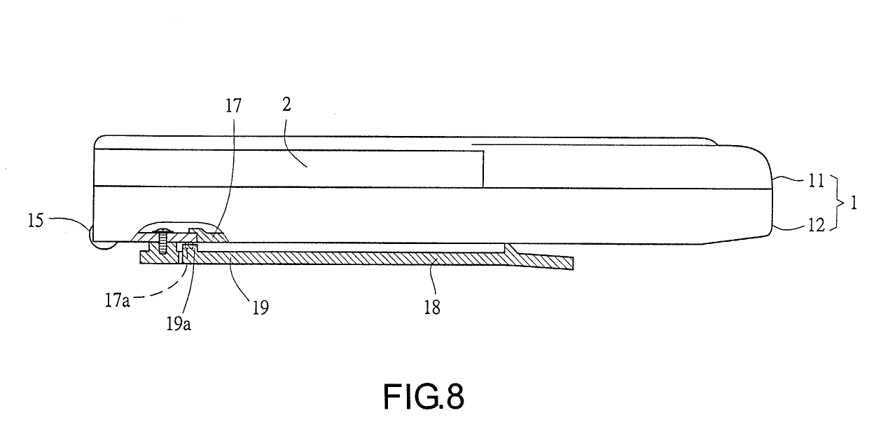

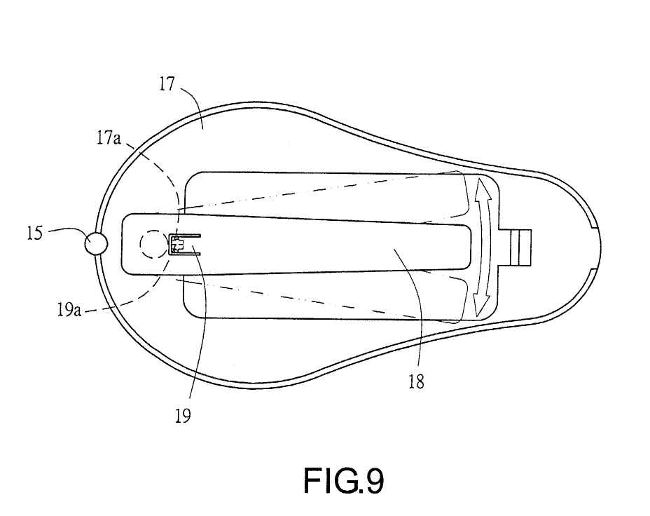

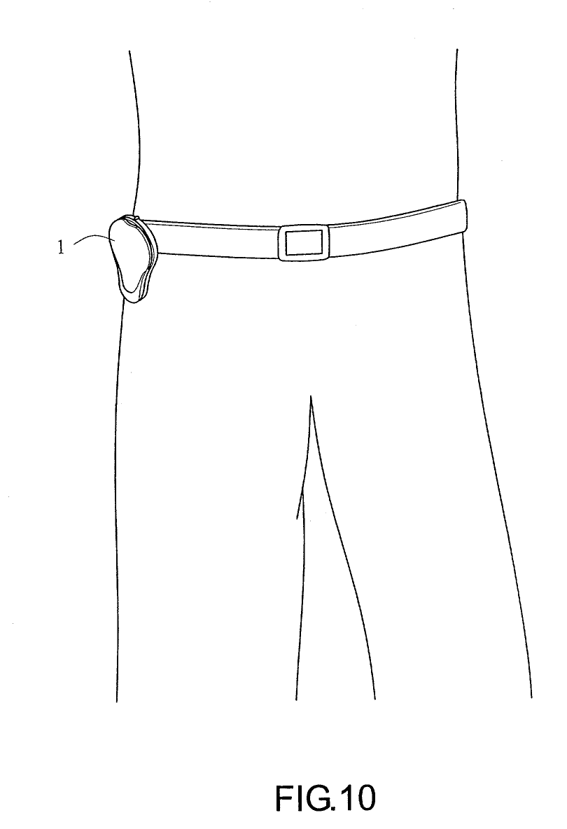

Referring to FIGS. 8 and 9, a face plate (17) is disposed at the lower aspect of the lower case body (12); the face plate (17) has a positioning annular tooth (17a) which is pivotally disposed with a retaining clip (18); a elastic piece (19) with a positioning tooth (19a) is disposed on the retaining clip (18) thereby making the retaining clip (18) lean against on the positioning annular tooth (17a) of the face plate (17) via the positioning tooth (19a) of the elastic piece (19) for deflecting and positioning to facilitate the user adjusting the angle of the retaining clip (18) so as to clip the present invention on a waist belt or other location, as shown in FIG. 10.

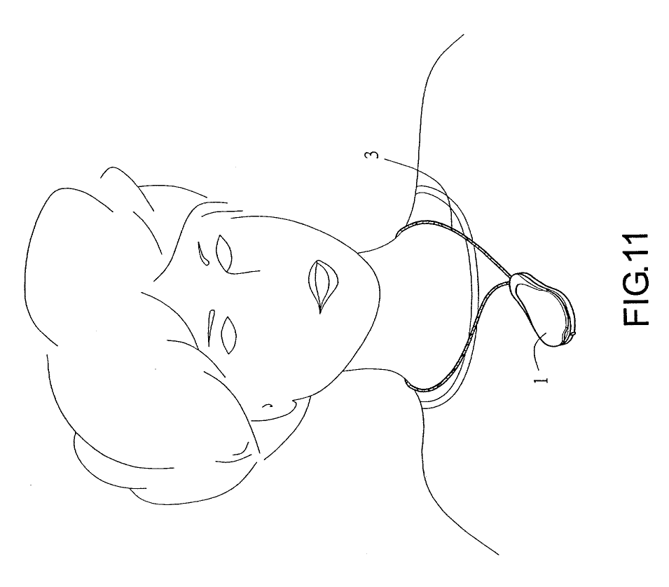

Referring to FIGS. 6 and 11, a hanging hole (10) is disposed at the rear end of the case body (1) and is penetrated by a hanging string (3). Therefore, the present invention is hung on the user's body via the hanging string (3). This is another embodiment of the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An extendable magnifier comprising:
a case body assembled by an upper case body and a lower case body; a receiving space is formed between the upper case body and the lower case body; two slide grooves are disposed on the bottom plane of the lower case body; an outer end of one of the slide grooves is disposed with a pair of elastic tab switches hidden in and not protruding outside the case body; a photo-diode with high brightness is disposed at the front end of the lower case body and a battery is disposed inside the lower case body;
a lens frame is disposed in the receiving space of the case body; a magnifying lens is disposed on the lens frame; a L-shape guide block opposite the slide groove of the lower case body is disposed on the bottom plane of the lens frame allowing the lens frame to extend outside or contract into the receiving space of the case body; when the lens frame is pushed outside the receiving space, the L-shape guide block on the lens frame presses the elastic tab switch on the lower case body so as to light up the photo-diode with high brightness and disposed at the front aspect of the lower case body for illuminating application.

2. An extendable magnifying according to claim 1, wherein a face plate is disposed at the lower aspect of the lower case body; the face plate has a positioning annular tooth which is pivotally disposed with a retaining clip; a elastic piece with a positioning tooth is disposed on the retaining clip thereby making the retaining clip lean against on the positioning annular tooth of the face plate via the positioning tooth of the elastic piece for deflecting and positioning.
